(19) United States
(12) Patent Application Publication
(10) Pub. No.: US 2026/0214416 A1
(43) Pub. Date: Jul. 23, 2026

(54) A PEST CONTROL DEVICE, A PEST CONTROL SYSTEM AND A METHOD FOR CONFIGURING THE PEST CONTROL SYSTEM

(71) Applicant: ANTICIMEX INNOVATION CENTER A/S, Helsinge (DK)

(72) Inventors: Rasmus SKOU, Kokkedal (DK); Peter HOHNEN, Tikøb (DK); Tomas OLSSON, Malmö (SE); Peter JONES, Lund (SE)

(73) Assignee: ANTICIMEX INNOVATION CENTER A/S, Helsinge (DK)

(21) Appl. No.: 19/142,725

(22) PCT Filed: Dec. 18, 2023
(86) PCT No.: PCT/EP2023/086466

§ 371 Date: Jun. 24, 2025

(30) Foreign Application Priority Data
Dec. 28, 2022 (DK) PA 2022 70653

(51) Int. Cl. H04W 4/30; A01M 1/00; A01M 23/00; H04W 12/03; H04W 72/0453; H04W 72/51; H04W 84/18

(52) U.S. Cl. CPC H04W 4/30; A01M 1/00; A01M 23/00; H04W 12/03; H04W 72/0453; H04W 72/51; H04W 84/18

(57) ABSTRACT

A method for configuring a pest control system is provided. The pest control system includes a gateway and a number of nodes arranged to communicate with each other via wireless data communication; wherein the wireless data communication is performed by using a rendezvous frequency for adding nodes to the system and a network communication frequency for communication between the nodes in the system. A pest control device and a gateway for use in a network of pest control devices of the system are further provided.

### TECHNICAL FIELD

The invention generally relates to pest control. More particularly, it is related to a pest control system, a method for configuring the pest control system, a pest control device and a gateway for use in said system.

### BACKGROUND ART

In most cities in the world the presence of rodents, in particular rats, is a problem. As the cities and the population in the cites grow, the problem becomes larger. Even though pest control has developed immensely during the last decades, severe damages are still today caused by rodents. The damages are not only direct damages, e.g. food or crops being eaten by rodents, but also indirect damages causing sanitary issues for households or business as well as spreading of diseases. Having reliable and efficient pest control is therefore important from a wide range of aspects.

Insects may also cause problems. Problems associated with insects range from being a nuisance to actually causing tangible damages, for instance, by spreading diseases, ruining food or crops, destroying clothes, furniture, or even building materials. As a result, property, buildings or other living spaces may become uninhabitable. To date, there has especially been a need for developing pest control for mosquitoes, cockroaches and flies, but the increased globalization leads to higher risk of global spreading of harmful insects.

New and improved methods for pest control are consequently being developed on an ongoing basis, a great deal of which is based on insecticides, pesticides, while other methods use actual traps, containing mechanical and/or electric means for pest control.

During the last few years, digitally connected pest control devices have become increasingly popular. For instance, the SMART solutions developed and marketed by Anticimex™ is one example well-known in the industry of pest control. By having pest control devices, or sensors for monitoring connected to the Internet, continuous monitoring of these is made possible. This has the advantage that the need for manually checking the pest control devices is reduced or in some cases completely removed. The workload for an operator monitoring or operating the pest control devices may thereby be reduced.

Even though modern pest control systems offer sensors and traps enabling remote monitoring, there is still room for improvement. One way is to implement networks of pest control devices. In the network the pest control devices may communicate wirelessly to each other or to a central unit. More robust pest control systems may thereby be obtained. An improved monitoring of animals or insects presence at a location or in an area may moreover be obtained by comparing data from different pest control devices in the network. A further advantage of having a network of inter communicating pest control devices is that a more reliable system may be provided as the system may be capable of ensuring, to a higher degree, that communication is maintained even if one or more devices in the network is interrupted or damaged. The complexity of such networks may, however, increase significantly. To this end, the regulatory requirements for providing such systems on a market are also more complex and may differ between different countries or regions. By way of example, the CE mark on a product indicates that the manufacturer or importer of such a product affirms compliance with the relevant EU legislation. The product may thereby be sold anywhere in the European Economic Area. By way of another example, the Federal Communications Commission certification or FCC mark is in the United States a certification mark required for electronic products manufactured or sold in the United States.

From a commercial point of view, there is therefore a need to provide pest control devices and systems of pest control devices that in addition to being efficient and cost-effective as such they need also to comply with strict compliance requirements in a country or a region.

### SUMMARY

It is an object of the invention to at least partly overcome one or more of the above-identified limitations of the prior art. In particular, it is an object to provide a pest control system that ensures failsafe compliance with local requirements such as quality and certification regulations. A system or parts thereof that may be offered in different countries or regions worldwide are moreover provided.

According to a first aspect a pest control system is provided. The pest control system comprises: a gateway and a number of nodes; wherein the gateway and the number of nodes, each comprises a wireless data communication unit, for wireless data communication with each other, said wireless data communication unit being configured to perform wireless data communication using a rendezvous frequency for adding nodes to the system and a network communication frequency for communication between the nodes in the system;
wherein said gateway comprises an external network communication unit for communicating, via a mobile network, with a backend server or a mobile device; and
wherein said gateway comprises a gateway memory holding a list of frequencies comprising at least one rendezvous frequency and at least one network communication frequency, said at least one rendezvous frequency and said at least one network communication frequency being linked to geographical location data;
said gateway memory further comprises an encryption module and a decryption module for enabling safe communication with the nodes; and
wherein each node comprises a node memory holding a list of frequencies comprising rendezvous frequencies and network communication frequencies, the network communication frequencies being matched to the rendezvous frequencies, respectively;
said node memory further comprises an encryption module and a decryption module for enabling safe communication with the gateway or other nodes; and
wherein the gateway is further configured to:
   determine the geographical location data based on data received from the mobile network;
   identifying in the gateway memory a selected rendezvous frequency and a selected network communication frequency based on the determined geographical location data;
   broadcasting by using the wireless data communication unit encrypted data on the selected rendezvous frequency; wherein the encrypted data is encrypted by using the encryption module of the gateway; and wherein each of the nodes is configured to:
   scan through a number of candidate frequencies provided in the list of frequencies of the node memory until the selected rendezvous frequency is identified;
   for each candidate frequency:
      capture data transmitted;
         in case the captured data is successfully decrypted by the decryption module of the current node:
         assign the current candidate frequency as selected rendezvous frequency for the current node;
         identify a selected network communication frequency matched to the selected rendezvous frequency by using the list of frequencies held in the node memory of the current node, thereby enabling wireless data communication at the selected network communication frequency.

An advantage with this first aspect is that a pest control system is provided that is configurable in a robust and failsafe manner. Risks associated with the gateway and/or the nodes communicating on an erroneous frequency are, moreover, reduced. A more efficient pest control system may further be provided. In the context pest control systems there is a need for robust systems that can be set up in a shorter time. The system further allows for reliable and efficient communication between the nodes and/or the gateway.

A system that may be utilized in different regions and countries worldwide is also provided. A more efficient logistic supply chain may further be achieved. A more efficient production of the system and parts thereof may also be achieved.

In more detail, the gateway and/or the nodes of the system may be offered in different countries or regions. Put differently, the same type of unit, i.e. gateway or node, may be imported to, sold in and used in different countries or regions without modifications. This, while complying with local regulation such as quality and certification specifications required to offer products in that country or region. A more efficient distribution of the system or parts of the system may therefore be achieved. A larger market for offering the system or parts thereof is thereby achieved.

The external network communication unit and the wireless data communication of the gateway may be the same unit. Alternatively, the external network communication unit and the wireless data communication of the gateway may be separate units having different functionality and/or hardware.

At least one of the nodes may be a pest control device.

The wording pest should be construed broadly and may comprise animals such as rats, mice, ferrets, minks, moles and rodents in general as well as insects such as cockroaches, mosquitos, flies and grasshoppers.

The pest control device may be a trap device for an animal or an insect, a monitoring device, or both a trap and a monitoring device.

The system may thereby further allow for reliable and efficient communication between the traps devices and/or monitoring devices and the gateway. As a result, quick removal of an animal caught in the trap device may be obtained, which also may be a legal requirement in a country.

Each node may be a pest control device, and each pest control device may be arranged to communicate via wireless data communication whether or not an animal or an insect is trapped and/or registered by the pest control device using the selected network communication frequency.

Efficient communication between the pest control devices may thereby be provided. By having an efficient configuration of and communication within a pest control system a new system may quickly be implemented at a location where there is a need for pest control. This could, for example, be a rat invasion in a residential area after construction work or changes to a sewage system. Quick installation of a pest control system further allows for extended service time for the pest control devices, e.g. reduced energy consumption during installation. The pest control system may be battery powered. Hence, an operator may have to change or charge a battery less frequently.

A cost-effective configuration e.g. during installation of a new pest control system at a location may allow for additional pest control devices to be used. A more efficient pest control may thereby be obtained.

According to a second aspect a method for configuring a pest control system is provided. The pest control system comprises: a gateway and a number of nodes arranged to communicate with each other via wireless data communication;
wherein said wireless data communication is performed by using a rendezvous frequency for adding nodes to the system and a network communication frequency for communication between the nodes in the system;
wherein said gateway is further arranged to communicate via a mobile network with a backend server or a mobile device using an external network communication unit;
wherein said gateway comprises a gateway memory holding a list of frequencies comprising at least one rendezvous frequency and at least one matching network communication frequency, said at least one rendezvous frequency and said at least one network communication frequency being linked to geographical location data;
said gateway memory further comprises an encryption module and a decryption module for enabling safe communication with the nodes; and
wherein each node comprises a node memory holding a list of frequencies comprising rendezvous frequencies and network communication frequencies, the network communication frequencies being matched to the rendezvous frequencies, respectively,
said node memory further comprises an encryption module and a decryption module for enabling safe communication with the gateway or other nodes;
said method comprising;
by the gateway:
determining, the geographical location data based on data received from the mobile network;
identifying a selected rendezvous frequency and a selected network communication frequency in the gateway memory based on the determined geographical location data;
broadcasting encrypted data on the selected rendezvous frequency; wherein the encrypted data is encrypted by using the encryption module of the gateway; and
by each of the nodes:
scanning through a number of candidate frequencies provided in the list of frequencies of the node memory until the selected rendezvous frequency is identified;
   for each candidate frequency:
      capturing data transmitted;
      in case the captured data is successfully decrypted by the decryption
         module of the current node:
         assigning the current candidate frequency as selected rendezvous frequency for the current node;
         identifying a selected network communication frequency matching the selected rendezvous frequency by using the list of frequencies held in the node memory of the current node, thereby enabling wireless data communication at the selected network communication frequency.

In line with the features and advantages presented above with respect to the first aspect, an advantage of the method is that a cost and time efficient configuration of the pest control system is achieved. There are in addition fewer constraints when configuring the nodes of the pest control system. Put differently, the same or similar nodes may be used in networks at different geographical locations. An advantage is that the same system may be distributed globally. Risks associated with the gateway and/or the nodes communicating on different and/or on erroneous frequencies are, moreover, reduced. A more trustworthy network is moreover provided for pest control.

A further advantage is that the gateway may be configured such that in any other country or region not comprised in the list of frequencies the gateway may not start transmitting data. Hence there will be no data communication in the network communication frequency if the gateway is used in such country or region. Quality considerations for the gateway and the pest control system may thereby be met.

Compliance with local regulations can thereby be achieved in an efficient manner. A larger market for offering the system is further achieved. To this end, a node is not allowed to transmit data by wireless data communication before having identified the selected network communication frequency matching the selected rendezvous frequency. The risk of a node using a frequency not allowed in the county or region in which the node is located is reduced.

Another advantage with the system is that a wireless network is provided that is less complex to set up. Erroneous signalling at restricted frequencies is further mitigated.

The wording adding nodes to the system should be broadly interpreted. The nodes may be new nodes. The nodes may alternatively be nodes previously used by the network that are reused or reassigned.

The gateway and the number of nodes communicate with each other via wireless data communication. The gateway and the number of nodes form a wireless data communication network. The wireless data communication network may be structured into sub-networks. The sub-network may comprise one or more nodes of the number of nodes. The sub-network is configured to communicate with the gateway.

The encryption module may be construed as module configured to transform understandable data into an unintelligible form. This to prevent the unauthorized use of the data e.g. for communication of data within the system. A safer system may therefore be obtained. Problems associated with a third party intervening or eavesdropping may therefore be reduced. To read an encrypted file, access to a secret decryption key or password is be required. The unencrypted data may be referred to as plain text. The encrypted data may be referred to as cipher text.

The decryption module should correspondingly be understood as a module configured to transform data from an unreadable to readable form. Put differently, transforming encrypted data to unencrypted data.

The data may pertain to a status of a node. The data may pertain to an observable of the node. The data may pertain to sensor data from a sensor of a node.

The wording gateway may be understood as device that connects networks together. The networks may have different transmission protocols. Put differently, the gateway may be an entry point and exit point for data communication between different networks. By way of example, data communicated via wireless data communication between a node and the gateway may be routed by the gateway to the backend server or the mobile device via the mobile network. The gateway may further route data between two sub-networks or trees of nodes, where the node of the sub-network or of the tree communicate via wireless data communication with other nodes in the same sub-network or tree of nodes.

A node may be understood as an end point or a branch point in the system. A node may be understood as a device that may send, receive, or forward data.

The selected communication frequency for communication between the nodes in the system may further be used for communication between the gateway and the nodes. In other words, the gateway and a node may be configured to communicate with each other at the network communication frequency.

The gateway and a node may be configured to communicate with each other at the rendezvous frequency.

The mobile network may in some examples be referred to as a mobile telecommunications network.

The wireless data communication may be understood as communication over a wireless network comprising multiple devices where data is sent and received over radio frequencies between the multiple devices. The multiple devices may, by way of example comprise a node and a gateway.

The current node may be configured to transmit, upon successful identifying of the selected network communication frequency, a confirmation message on the selected rendezvous frequency to the gateway. An advantage being that an efficient pairing of the node and the gateway is achieved.

The method may further comprise transmitting data between the nodes by using the selected network communication frequency.

The geographical location data may comprise a Mobile Country Code, MCC. An advantage being that the location of the gateway may be efficiently determined. An unique location specific location data may thereby be received by the gateway. The Mobile Country Code MCC is, moreover, defined by ITU-T as standard E.212. The MCC may be understood as is a mobile code consisting of three digits used to identify for example GSM networks. To this end, the MCC may be used along with the International Mobile Subscriber Identity (IMSI) to identify the region from which mobile subscriber belongs.

Every operator may be uniquely identified by a combination of Mobile Country Code (MCC) and Mobile Network Code (MNC). Such a combination may, by way of example, be used by mobile devices that operate using GSM, WCDMA, LTE, iDEN public land mobile networks as well as some CDMA, TETRA, and satellite mobile networks.

The list of frequencies of the gateway and/or the number of nodes may comprise pairs of rendezvous frequencies and network communication frequencies.

Each of the number of nodes may be configured to perform the scanning through a number of candidate frequencies, by scanning through a number of rendezvous frequencies for beacons for a set time period at the time, and wherein the captured data pertains to a beacon broadcasted by the gateway.

According to a third aspect a pest control device configured to be used as a node in a system forming a network of pest control devices is provided. The pest control device comprises a wireless data communication unit configured to perform wireless data communication using a rendezvous frequency for adding nodes to the system and a network communication frequency for wireless data communication between the pest control devices in the system, the pest control device further comprises a node memory holding a list of frequencies comprising rendezvous frequencies and network communication frequencies, the network communication frequencies being matched to the rendezvous frequencies, respectively; said node memory further comprises an encryption module and a decryption module for enabling safe communication with a gateway or other pest control devices;
wherein the pest control device is configured to:
scan through a number of candidate frequencies provided in the list of frequencies of the node memory until the selected rendezvous frequency is identified;
   for each candidate frequency:
      capture data transmitted;
         in case the captured data is successfully decrypted by the decryption module:
         assign the current candidate frequency as selected rendezvous frequency;
         identify a selected network communication frequency matched to the selected rendezvous frequency by using the list of frequencies held in the node memory, thereby enabling wireless data communication at the selected network communication frequency.

In line with the features and advantages presented above with respect to the first and second aspects, an advantage with this third aspect is that a pest control device is provided that is configurable ins a robust and failsafe manner. Risks associated with the pest control device communicating with other pest control devices or the gateway in an erroneous frequency are, moreover, reduced. A more efficient pest control device is further be provided. A pest control device is further provided that can be utilized in different regions or countries. An improved distribution of pest control devices for different markets may further be achieved. A simplified line of production is also obtainable. Put differently, the same type of pest control devices may be offered in different markets while complying with local or regional regulations.

The pest control device may be a trap device for an animal or an insect, a monitoring device, or both a trap and a monitoring device.

The monitoring device may comprise a sensor for detecting an animal or an insect, and wherein the monitoring device is configured to signal, via wireless data communication and using the selected network communication frequency, whether an animal or an insect is detected or not.

The trap device and/or the monitoring device may comprise electronic means for transmitting operational parameters or state data to other trap devices and/or monitoring devices via the wireless data communication.

The wireless data communication may further be from a trap device or a monitoring device to the gateway. The gateway may further communicate data pertaining to operational parameters and/or status data via the mobile network such that such parameters or data may be monitored from afar, e.g. via the Internet.

The trap device may further be arranged to be in a loaded state or an unloaded state, and wherein the trap device comprises a state sensor for determining the state of the trap device, and wherein the trap device may further be configured to signal, via wireless data communication using the selected network communication frequency, the state the trap device.

The trap device may further comprise a trapping sensor for determining if an animal or an insect is trapped or not by the trap device, and wherein the trap device is configured to signal, via wireless data communication and using the selected network communication frequency, whether an animal or an insect is trapped or not.

Sensor data from the state sensor or trapping sensor may, moreover, be transmitted by use of the gateway, via the mobile network, to, for instance, an operator. The system may therefore allow for increased number of trap devices or monitoring devices to be monitored centrally in an efficient manner.

According to a fourth aspect, a gateway configured to be used in a system forming a network of pest control devices is provided. The pest control devices are configured to be used as nodes in the network, wherein said gateway comprises a wireless data communication unit for wireless data communication with the pest control devices, said wireless data communication unit being configured to perform the wireless data communication using a rendezvous frequency for adding nodes to the network and a network communication frequency for communication between the nodes in the system; wherein said gateway comprises an external network communication unit for communicating, via a mobile network, with a backend server or a mobile device; and
wherein said gateway comprises a gateway memory holding a list of frequencies comprising at least one rendezvous frequency and at least one network communication frequency, said at least one rendezvous frequency and said at least one network communication frequency being linked to geographical location data;
said gateway memory further comprises an encryption module and a decryption module for enabling safe communication with the pest control devices; and
wherein the gateway is further configured to:
determine the geographical location data based on data received from the mobile network;
identifying in the gateway memory a selected rendezvous frequency and a selected network communication frequency based on the determined geographical location data;
broadcasting by using the wireless data communication unit encrypted data on the selected rendezvous frequency; wherein the encrypted data is encrypted by using the encryption module of the gateway.

In line with the features and advantages presented above with respect to the first, second, and third aspects an advantage with this fourth aspect is that a gateway is provided that can be offered in different countries or regions. An improved distribution of gateways for different markets may further be achieved. A cost-effective line of production may also be provided.

Further it is provided a node for use in the pest control system according to the first aspect.

Further it is provided a gateway for use in the pest control system according to the first aspect.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 generally illustrates a pest control system according to some examples.

FIG. 2 is a flowchart illustrating a method for configuring a pest control system according to some examples.

FIG. 3 generally illustrates a pest control system according to some examples.

### DETAILED DESCRIPTION

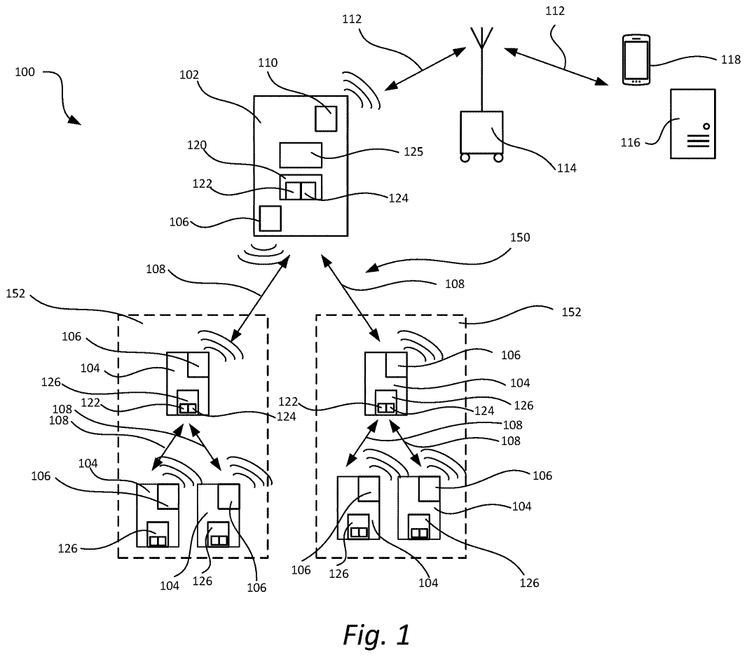

FIG. 1 generally illustrates a pest control system 100. The pest control system 100 comprising a gateway 102 and a number of nodes 104. The nodes 104 may be pest control devices, as will be discussed below.

The gateway 102 and the number of nodes 104, each comprises a wireless data communication unit 106. The wireless communication units 106 are arranged for wireless data communication between the nodes 104 and between a node 104 and the gateway 102. The wireless communication unit 106 may comprise a transceiver for data transmission and reception. The wireless communication units 106 of the gateway 102 and the nodes 104 may be the same type of unit or different units having similar functionality. The wireless data communication units 106 are configured to perform wireless data communication 108 using a rendezvous frequency for adding nodes 104 to the system 100 and a network communication frequency for communication between the nodes 104 in the system 100. The wireless data communication units 106 are further configured to perform wireless data communication 108 the network communication frequency for communication between the nodes 104 and the gateway 102.

The gateway 102 further comprises an external network communication unit 110 for communicating 112, via a mobile network 114, with a backend server 116 or a mobile device 118. Data communication 112 with the backend server 116 or the mobile device 118 may thereby be achieved. The mobile device 118 is here illustrated as a mobile phone but may in other examples be a tablet or other mobile devices. The external network communication unit 110 may comprise a transceiver for data transmission and reception. The gateway 102 may thereby communicate 112 by wireless communication via the mobile network 114.

The gateway 102 also comprises a gateway memory 120. The memory 120 may be a non-volatile memory. The memory 120 is configured to hold a list of frequencies comprising at least one rendezvous frequency and at least one network communication frequency. The at least one rendezvous frequency and the at least one network communication frequency being linked to geographical location data. The gateway memory may be a non-volatile memory.

The geographical location data is pertaining to a country or a region. The geographical location data may be understood as data comprising information of the position on earth. The geographic location data may in other examples comprise latitude and longitude relationships pertaining to a location. The wording location may be understood as a physical place or position coordinate on earth. The geographical location data may be may comprise position data from a global positioning system.

The geographical location data may comprise a Mobile Country Code, MCC. Thus, the location of the gateway 102 may be detected by the gateway 102 based on the Mobile Country Code, MCC, received from the mobile network 114.

The gateway memory 120 further comprises an encryption module 122 and a decryption module 124 for enabling safe communication with the nodes 104. In other examples, the encoder and/or decoder may form separate parts to the gateway memory 120. The gateway may further comprise a control unit 125. The control unit 125 may be understood as a unit configured to handle control signals, such as processor control signals. The control unit 125 may comprise circuitry for executing computer instructions. The control unit 125 may further direct and/or determine input and output parameters, receive and/or send instructions to run computer code. The control unit 125 may also be configured to monitor or direct other units and/or devices by control and timing signals.

The control unit 125 may be connected to the gateway memory 120, the external network communication unit 110 and/or the wireless data communication unit 106.

Each node 104 also comprises a memory, i.e. a node memory 126. The node memory may be a non-volatile memory. The node memory 126 holds a list of frequencies comprising rendezvous frequencies and network communication frequencies, the network communication frequencies being matched to the rendezvous frequencies, respectively.

The node memory 126 further comprises an encryption module 122 and a decryption module 124 for enabling safe communication with the gateway 102 or other nodes 104. The node may further comprise a control unit, not shown. The control unit may be connected to the node memory and/or the wireless communication module.

The gateway 102 is further configured to determine the geographical location data based on data received from the mobile network 114. The gateway 102 is also configured to identifying in the gateway memory 120 a selected rendezvous frequency and a selected network communication frequency based on the determined geographical location data. Put differently, the gateway 102 may be configured to support the regions and the countries based on the geographical location data. The gateway 102 may for example support regions, such as Europe and other regions or countries listed in the list of frequencies. The same type of gateway may as a consequence be offered in different countries or regions while complying with regulations stipulated for the respective countries or regions. In other words, the wireless data communication 108 is performed by using a rendezvous frequency for adding nodes 104 to the system 100 and a network communication frequency for communication between the nodes 104 in the system 100. The selected frequencies are based on the geographical location data. Table 1 illustrates, by way of example, a number of rendezvous and network communication frequencies for different regions

TABLE 1

| Frequency | Region | Usage |
|---|---|---|
| 868.3 MHz | Europe | Rendezvous and Network |
| | | communication frequency |
| 917.0 MHz | Outside of Europe | Network communication |
| | | frequency |
| 921.0 MHz | Outside of Europe | Rendezvous frequency |
| 922.0 MHz | Outside of Europe | Network communication |
| | | frequency |
| 924.0 MHz | Secondary frequency pair | Rendezvous and Network |
| | outside of Europe | communication |
| 926.0 MHz | Outside of Europe | Network communication |
| | | frequency |

The gateway 102 is further configured to broadcast by using the wireless data communication unit 106 encrypted data on the selected rendezvous frequency. The encrypted data is encrypted by using the encryption module 122 of the gateway 102.

Each of the nodes 104 is configured to scan through a number of candidate frequencies provided in the list of frequencies of the node memory 126 until the selected rendezvous frequency is identified. Each node 104 is further configured to for each candidate frequency capture data transmitted. Put differently, each node 104 is configured to capture data at different frequencies such that data transmitted by the gateway 102 may be captured and identified. In more detail, in case the captured data is successfully decrypted by the decryption module 124 of the current node 104, the current node is configured to assign the current candidate frequency as selected rendezvous frequency. The current node 104 is further configured to identify a selected network communication frequency matched to the selected rendezvous frequency by using the list of frequencies held in the node memory 126 of the current node 104. As a result, wireless data communication 108 between the nodes 104 and between a node 104 and the gateway 102 is enabled at the selected network communication frequency. Put differently, data may be transmitted using the selected network communication frequency between the nodes 104 after the configuration of the pest control system 100.

A further advantage is that the system 100 allows the gateway 102 and the nodes 104 to be configured to work in a given region and country. In other words, an efficient method for providing gateways and nodes for communication at given frequencies is provided. Thus, the gateway 102 and the nodes 104 may be configured to communication in countries and regions for which they are certified in an efficient manner. The same gateway 102 and/or nodes 104 may thereby be used in a multiple of countries or regions.

The current node 104 may further transmit, upon successful identifying of the selected network communication frequency, a confirmation message on the selected rendezvous frequency to the gateway 102. This enables a paring sequence to be completed between the gateway 102 and the current node 104.

Alternatively, the current node is configured to transmit a confirmation message on the selected network communication frequency to the gateway.

The gateway 102 and a number of nodes 104 may be understood to form a wireless data communication network 150. The wireless data communication network may be structured into sub-networks 152. The sub-network 152 may comprise one or more nodes of the number of nodes 104. The sub-network 152 may be configured to each communicate separately with the gateway 102. Each sub-network may have only one node configured to communicate with the gateway 102.

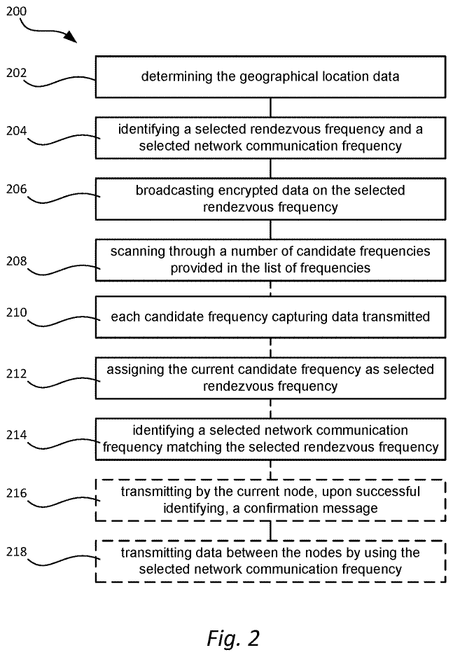

In the following, a method for configuring a pest control system according to some examples will be described with reference to the flowchart of FIG. 2 and the pest control system of FIG. 1. The pest control system 100 comprises a gateway 102 and a number of nodes 104 arranged to communicate with each other via wireless data communication 108, as illustrated in FIG. 1. The method 200, as exemplified in FIG. 2, comprises, by the gateway 102, determining 202 the geographical location data based on data received from the mobile network 114 and identifying 204 a selected rendezvous frequency and a selected network communication frequency in the gateway memory 120 based on the determined geographical location data. In more detail, the identifying is based on a list of frequencies comprising at least one rendezvous frequency and at least one matching network communication frequency being linked to geographical position data that is hold by the gateway memory 120.

The method 200 also comprises broadcasting 206 encrypted data on the selected rendezvous frequency. The encrypted data is encrypted by using the encryption module 122 of the gateway 102. The method 200 further comprises, by each of the nodes 104, scanning 208 through a number of candidate frequencies provided in the list of frequencies of the node memory 126 until the selected rendezvous frequency is identified and for each candidate frequency capturing 210 data transmitted. In case the captured data is successfully decrypted by the decryption module 124 of the current node 104 the method comprises assigning 212 the current candidate frequency as selected rendezvous frequency for the current node 104 and identifying 214 a selected network communication frequency matching the selected rendezvous frequency by using the list of frequencies held in the node memory 126 of the current node 104. Wireless data communication 108 at the selected network communication frequency is thereby enabled.

The method 200 may further comprise transmitting 216, by the current node 104, upon successful identifying 214 of the selected network communication frequency, a confirmation message on the selected rendezvous frequency to the gateway 102.

The method 200 may further comprise transmitting 218 data between the nodes 104 by using the selected network communication frequency.

Each of the number of nodes 104 may be configured to perform the scanning 208 through a number of candidate frequencies, by scanning 208 through a number of rendezvous frequencies for beacons for a set time period at the time, and wherein the captured data pertains to a beacon broadcasted 206 by the gateway 102. The time period may, by way of example, be in the range of 1 to 10 seconds.

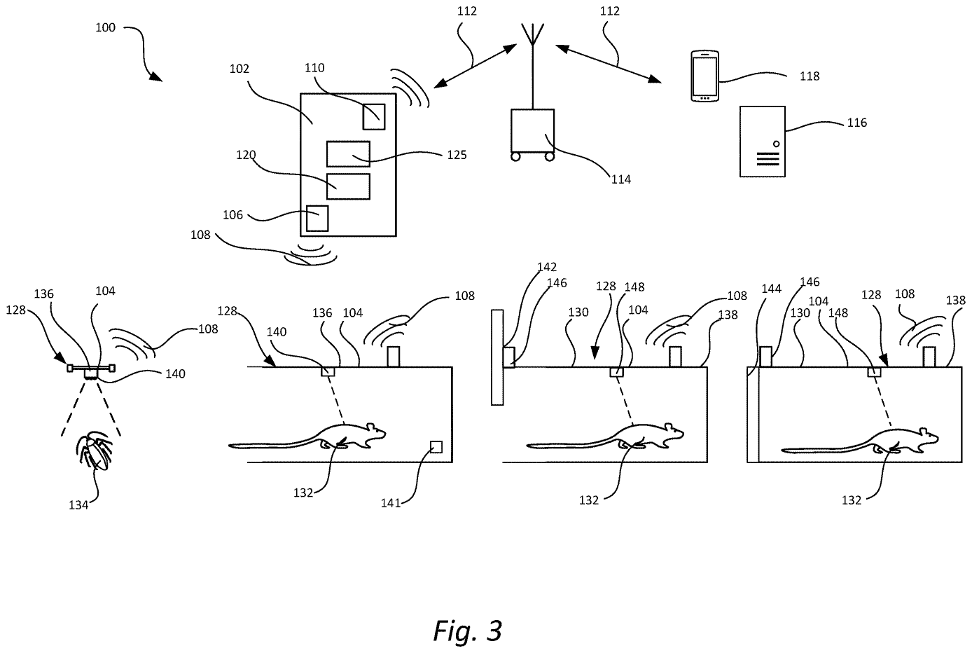

FIG. 3 generally illustrates a pest control system according to some examples. The pest control system 100 comprising a gateway 102 and a number of nodes 104. The gateway 102 and the number of nodes 104, each comprises a wireless data communication unit 106 for wireless data communication 108 with each other. The wireless data communication unit 106 being configured to perform wireless data communication 108 using a rendezvous frequency for adding nodes to the system and a network communication frequency for communication between the nodes 104 in the system 100, as described in relation to the best control system of FIG. 1. Hence, the system 100 of FIG. 3 may comprise similar parts and communicated in a similar manner as the system 100 of FIG. 1. The system 100 of FIG. 3 is arranged such that at least one of the nodes 104 is a pest control device 128. The pest control device 128 may be a trap device 130 for an animal 132 or an insect 134. The pest control device 128 may be alternatively be a monitoring device 136 or both a trap and a monitoring device 138, as also illustrated in FIG. 3.

In FIG. 3, each node 104 is exemplified as a pest control device 128. Each pest control device 128 may further be arranged to communicate via wireless data communication 108 whether or not an animal 132 or an insect 134 is trapped and/or registered by the pest control device 128 using the selected network communication frequency.

In FIG. 3 one of the nodes, is a monitoring device 136 for insects 134. The insects are illustrated by a cockroach but may in other examples be other insects such as termites, mosquitos, flies, grasshoppers etc. The monitoring device 136 comprises one or more sensors 140 for detecting insects 134. The one or more sensors 140 may, by way of example, be a motion sensor, an image sensor such as a camera, or an infra-red sensor. The sensor 140 is here exemplified as an image sensor. The image sensor may detect an individual insect or ensembles of insects. The monitoring device 136 may be configured such that a control unit of the pest control device 128 sends a signal via wireless data communication 108 and using the selected network communication frequency, whether an insect 134 has been detected or not. The signal sent pertains to sensor data from the one or more sensors 140. The monitoring device may comprise a bait for attracting insects, not shown.

FIG. 3 further illustrates, by way of example, three pest control devices arranged for monitoring and/or trapping of animals, here exemplified as rats 132. The pest control devices 128 may in other examples be arranged to monitor or trap mice, ferrets, minks, moles or other rodents. The first pest control device 128, farthest to the left of the pest control devices, comprises an infra-red sensor 140 for detecting the presence of a rat 132. The pest control device 128 is in the form of a monitoring device 136. The pest control device comprises a bait 141 for attracting rats 132. The bait 141 may, for example, be a smelling bait or a food bait.

As illustrated in FIG. 3 the pest control device 128 is in the form of a box arrangement into which the rat 132 may be lured. The box arrangement may have a predetermined size chosen to be suitable for a particular animal. The box arrangement may further have a cover and/or the entrance opening suitable for a certain type of animal.

As exemplified in FIG. 3, a rat 132 is present inside the box arrangement and the pest control device 128 may therefore signal, via wireless data communication 108 using the selected network communication frequency, that a rat 132 is registered.

The pest control devices 128 in the middle and farthest to the right in FIG. 3 are, by way of example, illustrating the same trap device 130 at different points in time. The trap device 130 is further arranged to be in a loaded state 142 or an unloaded state 144. The pest control device 128 further comprises a state sensor 146 for determining the state of the trap device 130, i.e. if the trap device 130 is in a loaded or unloaded state 142, 144. In more detail, the unloaded state 144 may be understood as a state where the trap device 130 is triggered in response to the presence of the animal. In FIG. 3 the loaded state 142 pertains to a closing mechanism being in an open position, i.e. such that an inner space of the box arrangement is accessible for a rat 132. In the loaded state 142 the trap device is arranged to trap when triggered. Put differently, the unloaded state 144 pertains to a closing mechanism being in a closed position such that the animal is trapped in the trap device 130. The trap device 130 is further configured to signal, via wireless data communication 108 using the selected network communication frequency, the state the trap device 130.

The trap device 130 may further comprise a trapping sensor 148 for detecting if an animal is trapped or not. The trapping sensor 148 may, by way of example, be a motion sensor, an image sensor such as a camera, an infra-red sensor. The trapping sensor 148 is here exemplified as a passive infra-red sensor. The trap device 130 may further be configured such that a control unit of the trap device 130 sends a signal via wireless data communication 108 and using the selected network communication frequency, the signal indicating whether an animal is or has been trapped or not. With such set-up it is therefore made possible to distinguish between true positives, i.e. the trap device is triggered (in an unloaded state), and the animal is present in the trap device, and false positives, i.e. the trap device is in the unloaded state, but no animal is present. To this end, the trap device 130 may be understood as both a trap and a monitoring device 138. Put differently, the trap device and monitoring device 138 of FIG. 3 may be understood as a device configured to combine the functionality of a trap device 130 with the functionality of a monitoring device 136.

In other examples, the trap device may comprise a spring mechanism which upon release can trap or kill an animal present in the trap device by a powerful and swinging movement. Put differently, the spring mechanism of the trap device may be in a loaded state or an unloaded state, the loaded state pertaining to the spring mechanism being loaded and the unloaded state pertaining to the spring mechanism being in a released state.

The signal transmitted from the trap device and/or the monitoring device may comprise data indicative of the presence of an animal or insect, i.e. if the animal or insect is detected or not. The signal transmitted from the trapping device may comprise data indicative of whether an animal or insect is present, i.e. trapped by the trapping device.

The sensors for monitoring an animal or insect may according to some examples be passive infra-red (PIR) sensors, but other sensors may also be used for detecting the rodents e.g. radar sensors or vision-based sensors. In addition to using sensors that can directly detect the rodents, it is also possible to use sensors that can indirectly detect the rodents or that can provide information that can be used for determining the likelihood of rodent activity. Examples of such sensors are temperature sensors, weight sensors, sound sensors, vibration sensor and gas sensors.

The pest control system may according to some examples be configured such that all data wirelessly communicated is encrypted.

Different keys may be used to encrypt or decrypt data for the wireless data communication. By way of example, a node key may be used, where the node key is unique for each node. The node key may be used only to distribute ta mesh key to a node when adding the node to the pest control system. A network key may be a unique key used within a network of nodes. The network key may be used for all data communication between nodes that are part of the same network. The network key may be distributed on the rendezvous frequency. A rendezvous key may further be used. The rendezvous key may be known by every node and may not be considered secret. The rendezvous key may be used to send beacons on the rendezvous frequency.

The wireless data communication may be performed using different power modes. In a normal power mode, by way of example, the power may be in a high-power range, for example comprising a power of 14 (11) dBm and used for normal communication within the network. The lower power value (within parenthesis) may be used when running on the 868.3 MHz frequency in a gateway to take power considerations into account, e.g. power specifications used for certification compliance, when positioning the gateway. In a routing mode the power may be in a medium power range, for example comprising a power of 9 (7) dBm used when setting up the routing in the network. The lower value (within parenthesis) may be used when running on the 868.3 MHz frequency in a gateway due to the normal mode power is lowered. In a beacon mode the power may be in a power range of close to 0 dBm thereby providing a low transmit power (shortest range), used for beacons. By using lower transmit power while setting up the network and then increase the transmit power once the network is set up the probability that the nodes are on the border of reaching each other decreases.

According to some examples, the trap device further comprises a trapping sensor for determining if an animal or an insect is trapped or not by the trap device, and wherein the trap device is configured to signal, via wireless data communication and using the selected network communication frequency, whether an animal or an insect is trapped or not.

According to some examples, a method for configuring a pest control system is provided. The pest control system may comprise a
gateway and a number of nodes arranged to communicate with each other via wireless data communication;
wherein said wireless data communication is performed by using a rendezvous frequency for adding nodes to the system and a network communication frequency for communication between the nodes in the system;
wherein said gateway is further arranged to communicate via a mobile network with a backend server or a mobile device using an external network communication unit;
wherein said gateway comprises a gateway memory holding a list of frequencies comprising at least one rendezvous frequency and at least one matching network communication frequency, said at least one rendezvous frequency and said at least one network communication frequency being linked to geographical location data;
and wherein each node comprises a node memory holding a list of frequencies comprising rendezvous frequencies and network communication frequencies, the network communication frequencies being matched to the rendezvous frequencies, respectively,
said method comprising;
by the gateway:
determining, the geographical location data based on data received from the mobile network;
identifying a selected rendezvous frequency and a selected network communication frequency in the gateway memory based on the determined geographical location data;
broadcasting data on the selected rendezvous frequency; and by each of the nodes:
   scanning through a number of candidate frequencies provided in the list of frequencies of the node memory until the selected rendezvous frequency is identified;
   for each candidate frequency:
      capturing data transmitted;
      in case the data is captured successful by the current node:
         assigning the current candidate frequency as selected rendezvous frequency for the current node;
         identifying a selected network communication frequency matching the selected rendezvous frequency by using the list of frequencies held in the node memory of the current node, thereby enabling wireless data communication at the selected network communication frequency.

According to some examples, a pest control device configured to be used as a node in a network of pest control devices is provided. The pest control device comprises a wireless data communication unit configured to perform wireless data communication using a rendezvous frequency for adding nodes to the system and a network communication frequency for wireless data communication between the pest control devices in the system, the pest control device further comprises a node memory holding a list of frequencies comprising rendezvous frequencies and network communication frequencies, the network communication frequencies being matched to the rendezvous frequencies, respectively;
wherein the pest control device is configured to:
scan through a number of candidate frequencies provided in the list of frequencies of the node memory until the selected rendezvous frequency is identified;
   for each candidate frequency:
      capture data transmitted;
         in case the data is captured successful:
         assign the current candidate frequency as selected rendezvous frequency;
         identify a selected network communication frequency matched to the selected rendezvous frequency by using the list of frequencies held in the node memory, thereby enabling wireless data communication at the selected network communication frequency.

According to some examples, a gateway configured to be used in a pest control system is provided, the pest control system forming a network of pest control devices. The gateway comprises a wireless data communication unit for wireless data communication with a number of nodes of the pest control system, said wireless data communication unit being configured to perform wireless data communication using a rendezvous frequency for adding nodes to the system and a network communication frequency for communication between the nodes in the system;
wherein said gateway comprises an external network communication unit for communicating, via a mobile network, with a backend server or a mobile device; and
wherein said gateway comprises a gateway memory holding a list of frequencies comprising at least one rendezvous frequency and at least one network communication frequency, said at least one rendezvous frequency and said at least one network communication frequency being linked to geographical location data; and
wherein the gateway is further configured to:
determine the geographical location data based on data received from the mobile network;
identifying in the gateway memory a selected rendezvous frequency and a selected network communication frequency based on the determined geographical location data;
broadcasting by using the wireless data communication unit data on the selected rendezvous frequency.

From the description above follows that, although various embodiments of the invention have been described and shown, the invention is not restricted thereto, but may also be embodied in other ways within the scope of the subject-matter defined in the following claims.

1. A method for configuring a pest control system, wherein the pest control system comprises:
a gateway; and
nodes arranged to communicate with each other via wireless data communication;
wherein the wireless data communication is performed by using a rendezvous frequency for adding the nodes to the pest control system and a network communication frequency for communication between the nodes in the pest control system;
wherein the gateway is further arranged to communicate, via a mobile network, with a backend server or a mobile device using an external network communication unit;
wherein the gateway comprises a gateway memory holding a list of frequencies comprising at least one rendezvous frequency and at least one matching network communication frequency, the at least one rendezvous frequency and the at least one network communication frequency being linked to geographical location data;
the gateway memory further comprises an encryption module and a decryption module for enabling safe communication with the nodes; and
wherein each of the nodes comprises a node memory holding a list of frequencies comprising rendezvous frequencies and network communication frequencies, the network communication frequencies being matched to the rendezvous frequencies, respectively;
the node memory of each of the nodes further comprises an encryption module and a decryption module for enabling safe communication with the gateway or other ones of the nodes;
the method comprising;
the gateway performing the following processes:
determining, the geographical location data based on data received from the mobile network;
identifying a selected rendezvous frequency and a selected network communication frequency in the gateway memory based on the determined geographical location data;
broadcasting encrypted data on the selected-rendezvous frequency; wherein the encrypted data is encrypted by using the encryption module of the gateway; and
each of the nodes performing the following processes:
scanning through a number of candidate frequencies provided in the list of frequencies of the node memory until the selected rendezvous frequency is identified;
for each candidate frequency:
capturing data transmitted;
in case the captured data is successfully decrypted by the decryption module of the current node:
assigning a the current candidate frequency as selected rendezvous frequency for the current node; and
identifying a selected network communication frequency matching the selected rendezvous frequency by using the list of frequencies held in the node memory of the current node, thereby enabling wireless data communication at the selected network communication frequency.

2. The method according to claim 1, wherein the current node is configured to transmit, upon successfully successful identifying of the selected network communication frequency, a confirmation message on the selected rendezvous frequency to the gateway.

3. The method according to claim 1, wherein the method further comprises transmitting data between the nodes by using the selected network communication frequency.

4. The method according to claim 1, wherein the geographical location data comprises a Mobile Country Code, MCC.

5. The method according to claim 1, wherein the list of frequencies of the gateway and/or the nodes comprises pairs of rendezvous frequencies and network communication frequencies.

6. The method-according to claim 1, wherein each of the nodes is configured to perform the scanning through a number of candidate frequencies, by scanning through a number of rendezvous frequencies for beacons for a set time period at the time, and wherein the captured data pertains to a beacon broadcasted by the gateway.

7. A pest control system comprising:
a gateway; and
nodes;
wherein the gateway and the nodes, comprises a wireless data communication unit, for wireless data communication with each other, the wireless data communication unit being configured to perform wireless data communication using a rendezvous frequency for adding the nodes to the pest control system and a network communication frequency for communication between the nodes in the pest control system;
wherein the gateway comprises an external network communication unit for communicating, via a mobile network, with a backend server or a mobile device; and
wherein the gateway comprises a gateway memory holding a list of frequencies comprising at least one-rendezvous frequency and at least one network communication frequency, the at least one rendezvous frequency and the at least one network communication frequency being linked to geographical location data;
the gateway memory further comprises an encryption module and a decryption module for enabling safe communication with the nodes; and
wherein each of the nodes comprises a node memory holding a list of frequencies comprising rendezvous frequencies and network communication frequencies, the network communication frequencies being matched to the rendezvous frequencies, respectively;
the node memory further comprises an encryption module and a decryption module for enabling safe communication with the gateway or other ones of the nodes; and
wherein the gateway is further configured to:
determine the geographical location data based on data received from the mobile network;
identifying in the gateway memory a selected rendezvous frequency and a selected network communication frequency based on the determined geographical location data;
broadcasting by using the wireless data communication unit encrypted data on the selected rendezvous frequency; wherein the encrypted data is encrypted by using the encryption module of the gateway; and
wherein each of the nodes is configured to:
scan through a number of candidate frequencies provided in the list of frequencies of the node memory until the selected rendezvous frequency is identified;
for each candidate frequency:
capture data transmitted;
in case the captured data is successfully decrypted by the decryption module of the current node:
assign the current candidate frequency as selected rendezvous frequency for the current node; and
identify a selected network communication frequency matched to the selected rendezvous frequency by using the list of frequencies held in the node memory of the current node, thereby enabling wireless data communication at the selected network communication frequency.

8. The pest control system according to claim 7, wherein at least one of the nodes is a pest control device.

9. The pest control system according to claim 8, wherein the pest control device is a trap device for an animal or an insect, a monitoring device, or both a trap and a monitoring device.

10. The pest control system according to claim 9, wherein each of the nodes is a pest control device, and each pest control device is arranged to communicate via wireless data communication whether or not an animal or an insect is trapped and/or registered by the pest control device using the selected network communication frequency.

11. A pest control device configured to be used as a node in a system forming a network of pest control devices, the pest control device comprises;
a wireless data communication unit configured to perform wireless data communication using a rendezvous frequency for adding nodes to the system and a network communication frequency for wireless data communication between the pest control devices in the system;
a node memory holding a list of frequencies comprising rendezvous frequencies and network communication frequencies, the network communication frequencies being matched to the rendezvous frequencies, respectively;
the node memory further comprises an encryption module and a decryption module for enabling safe communication with a gateway or other ones of the pest control devices in the network of pest control devices;
wherein the pest control device is configured to:
scan through a number of candidate frequencies provided in the list of frequencies of the node memory until the selected rendezvous frequency is identified;
for each candidate frequency:
capture data transmitted;
in case the captured data is successfully decrypted by the decryption module:
assign the current candidate frequency as selected rendezvous frequency;
identify a selected-network communication frequency matched to the selected rendezvous frequency by using the list of frequencies held in the node memory, thereby enabling wireless data communication at the selected network communication frequency.

12. The pest control device according to claim 11, wherein the pest control device is a trap device for an animal or an insect, a monitoring device, or both a trap and a monitoring device.

13. The pest control device according to claim 12, wherein the monitoring device comprises a sensor for detecting an animal or an insect, and wherein the monitoring device is configured to signal, via wireless data communication and using the selected network communication frequency, whether an animal or an insect is detected or not.

14. The pest control device according to claim 12, wherein the trap device is further arranged to be in a loaded state or an unloaded state, and wherein the trap device comprises a state sensor for determining the state of the trap device, and wherein the trap device is further configured to signal, via wireless data communication using the selected network communication frequency, the state the trap device.

15. A gateway configured to be used in a system forming a network of pest control devices, the said pest control devices being configured to be used as nodes in the network, wherein the gateway comprises:
a wireless data communication unit for wireless data communication with the pest control devices, the wireless data communication unit being configured to perform the wireless data communication using a rendezvous frequency for adding nodes to the network and a network communication frequency for communication between the nodes in the system;
an external network communication unit for communicating, via a mobile network, with a backend server or a mobile device; and
a gateway memory holding a list of frequencies comprising at least one rendezvous frequency and at least one network communication frequency, the at least one rendezvous frequency and the at least one network communication frequency being linked to geographical location data;
the gateway memory further comprises an encryption module and a decryption module for enabling safe communication with the pest control devices; and
wherein the gateway is further configured to:
determine the geographical location data based on data received from the mobile network;
identifying in the gateway memory a selected-rendezvous frequency and a selected network communication frequency based on the determined geographical location data;
broadcasting by using the wireless data communication unit encrypted data on the selected rendezvous frequency; wherein the encrypted data is encrypted by using the encryption module of the gateway.
